(19) United States
(12) Patent Application Publication
(10) Pub. No.: US 2018/0222147 A1
(43) Pub. Date: Aug. 9, 2018

(54) FOAM PAD

(71) Applicant: CHA YAU SPONGE ENTERPRISE CO., LTD., LUKANG TOWN (TW)

(72) Inventor: Chien-Chuan Kao, LUKANG TOWN (TW)

(21) Appl. No.: 15/429,135

(22) Filed: Feb. 9, 2017

(51) Int. Cl. B32B 5/32; B32B 7/04; B32B 7/12; B32B 5/20; B32B 5/18

(52) U.S. Cl. CPC B32B 5/32; B32B 7/04; B32B 7/12; B32B 5/20; B32B 5/18; B32B 2307/744; B32B 2266/025; B32B 2607/00; B32B 2250/22; B32B 2250/24; B32B 2270/00; B32B 2266/0292; B32B 2266/0221; B32B 2307/554

(57) ABSTRACT

A foam pad structure has a mat body having at least one surface layer, the surface layer comprising TPE, EVA and a cured. PE material as an integrally formed foam. The cured PE material has PE particles uniformly mixed in a composite foam layer formed b the TPE and the EVA materials.

### BACKGROUND of INVENTION

### 1. Field of Invention

The present invention relates to a foam pad, and more particularly to a foam pad with anti-skid, wear-resistant effects.

### 2. Description of Related Art

Currently, one conventional mat structure made of EVA foam material is provided with equidistant recesses at the periphery in order to be used for large area assembly. They are designed with concave patterns and printed with EVA foam material having different colors of oil films and protective layers, and embossed decoration. Furthermore, the outline of the contour space cut into several blocks with different colors according to the design. In addition, the bottom surface has permeability and antislip effect, and the top surface has wear-resistant.

However, the conventional mats only has antislip effect on the embossed pattern formed on the surface of the concavo-convex surface and the concave portion is more susceptible to dirt which causes the loss of convex effect and significantly reduce the mat slip function.

Therefore, it is desirable to provide a shear with wheeled blades to mitigate and/or obviate the aforementioned problems.

### SUMMARY of INVENTION

An objective of present invention is to provide a foam pad which is capable of performing rotatory cutting.

In order to achieve the above mentioned objective, a foam pad structure has a mat body having at least one surface layer, the surface layer comprising TPE, EVA and a cured PE material integrally formed foam. The cured PE material has PE particles uniformly mixed in a composite foam layer formed by the TPE and the EVA materials.

Other objects, advantages, and novel features of invention will become more apparent from the following detailed description when taken in conjunction with the accompanying drawings.

### BRIEF DESCRIPTION OF DRAWINGS

FIG. 1 is a perspective drawing of a preferred embodiment of the present invention.

FIG. 2 is a schematic drawing of a surface layer according to preferred embodiment of the present invention.

FIG. 3 is an exploded drawing of the preferred embodiment of the present invention.

FIG. 4 is a cross-sectional view of the preferred embodiment of the present invention.

FIG. 5 is a perspective drawing of another embodiment of the present invention.

FIG. 6 is a cross-sectional view of another embodiment of the present invention.

FIG. 7 is a perspective drawing of another embodiment of the present invention.

FIG. 8 shows an actual application of the present invention.

### DETAILED DESCRIPTION OF PREFERRED EMBODIMENT

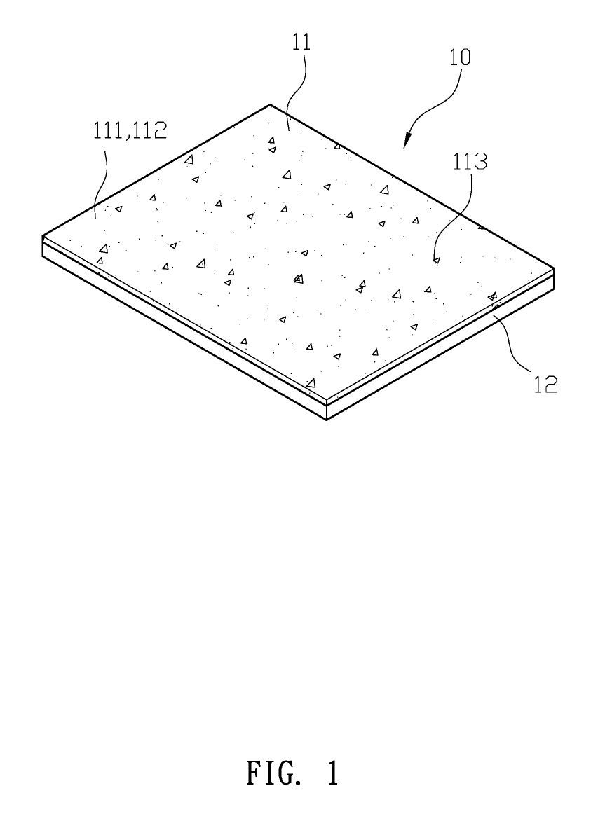

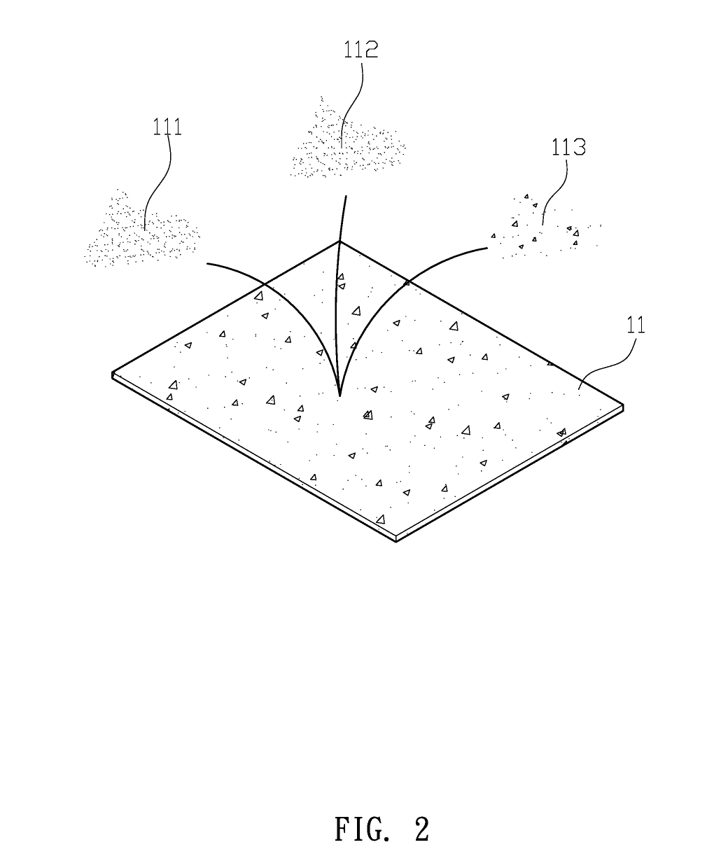

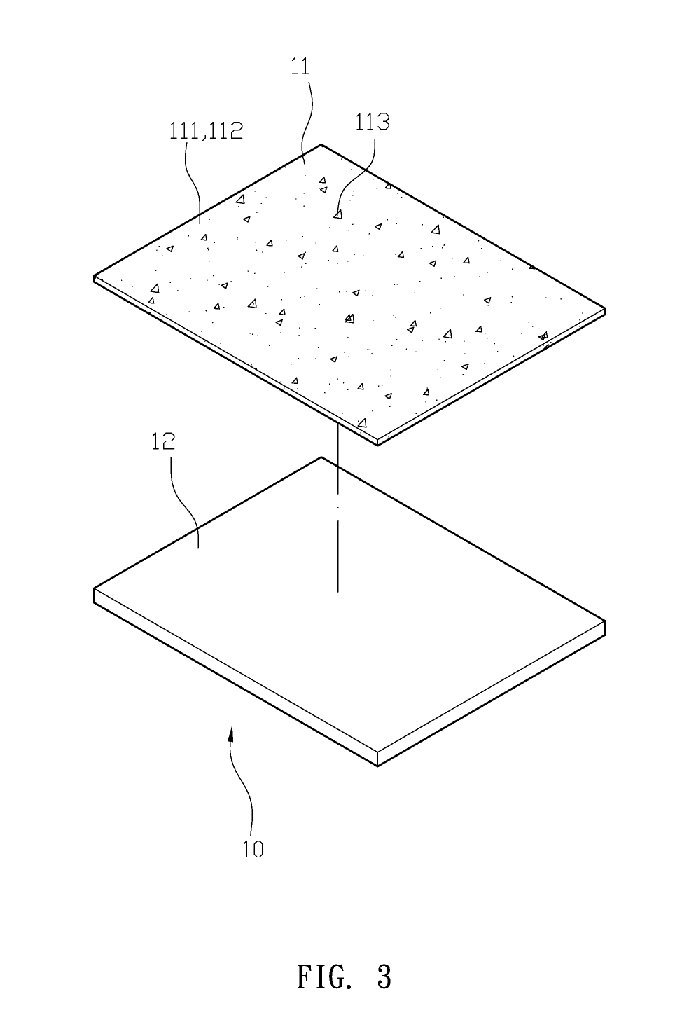

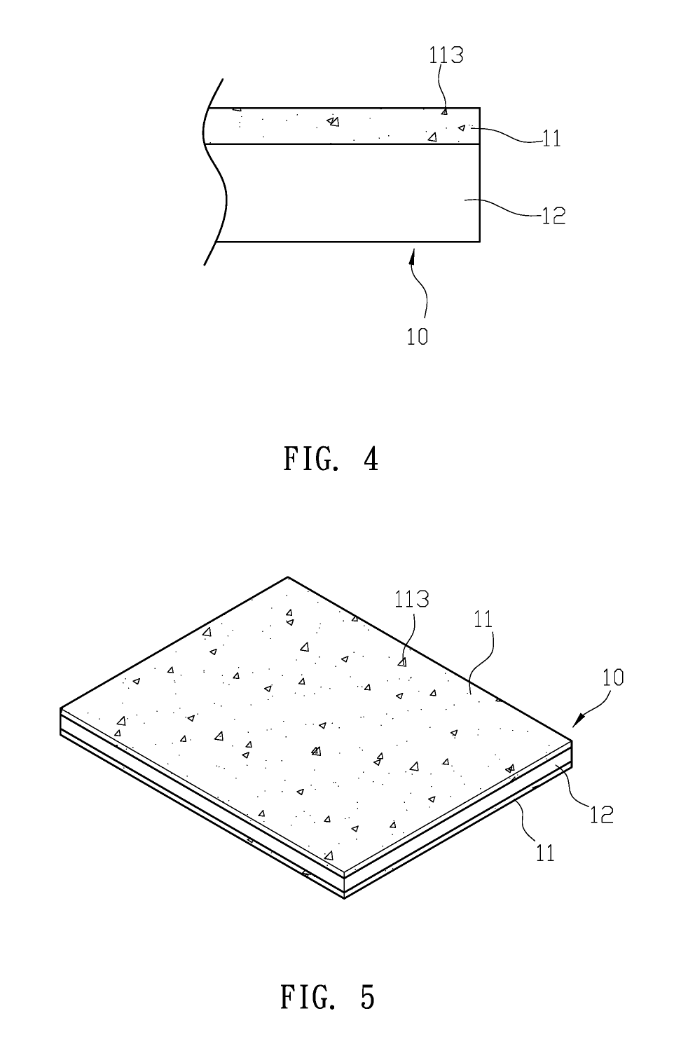

Please refer to FIG. 1 to FIG. 4. A foam pad structure comprises a mat body 10 having at least one surface layer 11 and a bottom layer 12. The surface 11 layer comprises a TPE material 111, an EVA material 112 and a cured PE material 123 as an integrally formed foam, wherein the cured PE material 123 comprises PE particles uniformly mixed in a composite foam layer formed by the TPE 111 and the EVA 112. In result, a top surface of the surface layer 11 is provide with better anti-slip and anti-wear effects with the combination of the cured PE 113 and TPE 111 but with lower adhesive ability, and the bottom layer 12 is EVA foam material or the PE foam material or a mixed foam material from the EVA and PE materials. The bottom layer 12 is disposed under the surface layer 11 and is attached by a hot melting process or with an adhesive. Furthermore, the surface layer 11 and the bottom layer 12 of the mat body 10 are combined during a foaming process.

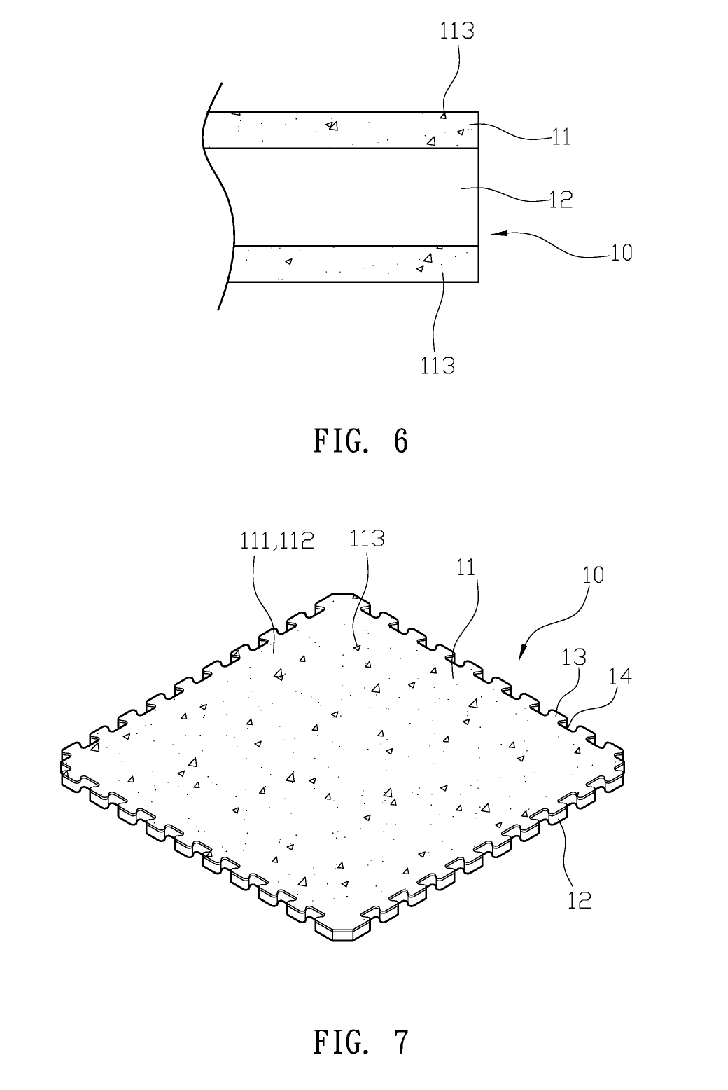

For another embodiment, please refer to FIG. 5 and FIG. 6. The mat body 10 comprises two surface layers 11, and both surfaces of the two surface layers 11 are mixed with the cured PE 113. A bottom layer 12 is sandwiched between the two surface layers 11.

For another embodiment, please refer to FIG. 7. The periphery of the mat body 10 is further provided by a plurality of corresponding assembling protrusions and assembling recesses.

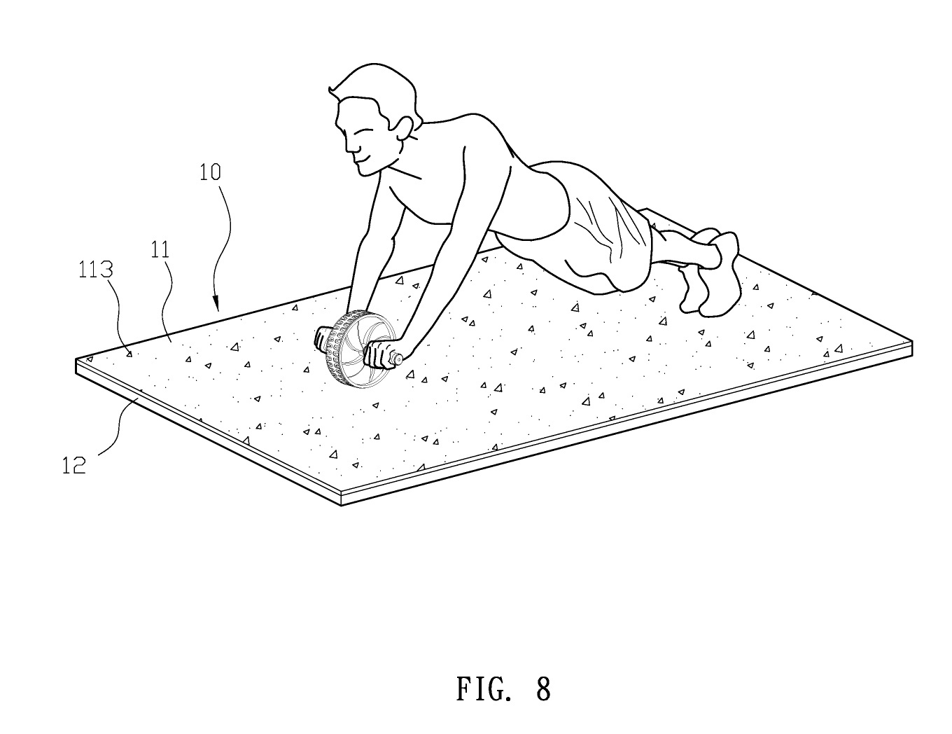

For actual application, please refer to FIG. 8. Since the surface layer 11 of the mat body 10 is composed of the TPE material 111, the EVA material 112 and a cured PE material 113 as an integrally formed foam and has better anti-slip and anti-wear effects, the mat body 10 is suitable for used as exercise pads.

Although the present invention has been explained in relation to its preferred embodiment, it is to be understood that many other possible modifications and variations can be made without departing from the spirit and scope of invention as hereinafter claimed.

What is claimed is:

1. A foam pad structure comprising a mat body having at least one surface layer, the surface layer comprising TPE, EVA and a cured PE material as an integrally formed foam, wherein the cured PE material comprises PE particles uniformly mixed in a composite foam layer formed by the TPE and the EVA materials.

2. The foam pad as claimed in claim 1, wherein the mat body further comprises a bottom layer disposed under the surface layer.

3. The foam pad as claimed in claim 2, wherein the bottom layer is an EVA foam material.

4. The foam pad as claimed in claim 2, wherein the bottom layer is a PE foam material.

5. The foam pad as claimed in claim 2, wherein the bottom layer is a multiple foam material comprising EVA and PE materials.

6. The foam pad as claimed in claim 2, wherein the mat body has two surface layers and a bottom layer sandwiched between the two surface layers.

7. The foam pad as claimed in claim 2, wherein the surface layer and the bottom layer of the mat body are combined by a hot melting process.

8. The foam pad as claimed in claim 2, wherein the surface layer and the bottom layer of the mat body are combined with an adhesive.

9. The foam pad as claimed in claim 2, wherein the surface layer and the bottom layer of the mat body are combined during a foaming process.

10. The foam pad as claimed in claim 3, wherein the surface layer and the bottom layer of the mat body are combined by a hot melting process.

11. The foam pad as claimed in claim 3, wherein the surface layer and the bottom layer of the mat body are combined with an adhesive.

12. The foam pad as claimed in claim 3, wherein the surface layer and the bottom layer of the mat body are combined during a foaming process.

13. The foam pad as claimed in claim 4, wherein the surface layer and the bottom layer of the mat body are combined by a hot melting process.

14. The foam pad as claimed in claim 4, wherein the surface layer and the bottom layer of the mat body are combined with an adhesive.

15. The foam pad as claimed in claim 4, wherein the surface layer and the bottom layer of the mat body are combined during a foaming process.

16. The foam pad as claimed in claim 5, wherein the surface layer and the bottom layer of the mat body are combined by a hot melting process.

17. The foam pad as claimed in claim 5, wherein the surface layer and the bottom layer of the mat body are combined with an adhesive.

18. The foam pad as claimed in claim 5, wherein the surface layer and the bottom layer of the mat body are combined during a foaming process.

19. The foam pad as claimed in claim 6, wherein the surface layer and the bottom layer of the mat body are combined by a hot melting process or an adhesive.

20. The foam pad as claimed in claim 6, wherein the surface layer and the bottom layer of the mat body are combined during a foaming process.
